(19) United States
(12) Patent Application Publication
(10) Pub. No.: US 2024/0295177 A1
(43) Pub. Date: Sep. 5, 2024

(54) HOUSING FOR AN AIRCRAFT TURBOMACHINE AND METHOD FOR HOUSING MANUFACTURE

(71) Applicant: SAFRAN AIRCRAFT ENGINES, Paris (FR)

(72) Inventors: Clement BOUROLLEAU, Moissy-Cramayel (FR); Clementine ARNOLD, Moissy-Cramayel (FR); Alexandre BRANCO, Moissy-Cramayel (FR); Serge DOMINGUES, Moissy-Cramayel (FR); Thomas DUPAYS, Moissy-Cramayel (FR); Vincent Pascal FIORE, Moissy-Cramayel (FR); Baptiste LEBLON, Moissy-Cramayel (FR); Anwer SIRAJ, Moissy-Cramayel (FR)

(21) Appl. No.: 18/003,403

(22) PCT Filed: Jun. 29, 2021
(86) PCT No.: PCT/FR2021/051195

§ 371 Date: Jun. 2, 2023

(30) Foreign Application Priority Data
Jun. 29, 2020 (FR) FR2006781

(51) Int. Cl. F01D 11/12; F01D 21/04

(52) U.S. Cl. CPC F01D 11/125; F01D 21/045; F05D 2220/36; F05D 2300/2102; F05D 2300/224

(57) ABSTRACT

A housing for an aircraft turbomachine, including an annular casing extending around an axis A and having an internal annular surface, the housing also including an annular abradable support cartridge that is fixed against the internal annular surface, the abradable support cartridge has a reinforced coating including a fibrous texture reinforcement embedded in a resin matrix, the fibrous texture reinforcement including a stack of fibrous texture plies, wherein the stack of plies includes at least one ply made of Kevlar® or of glass fibres.

### TECHNICAL FIELD OF THE INVENTION

The present invention relates to the production of a housing, in particular for a fan of an aircraft turbomachine.

### TECHNICAL BACKGROUND

The technical background comprises in particular the documents EP-A1-3192979, WO-A1-2020/044617 and EP-A1-3093450.

In a conventional way, a turbomachine comprises from upstream to downstream, i.e. in the direction of flow of the gas flows, a fan, one or more compressors, a combustion chamber, one or more turbines, and a nozzle for the ejection of the combustion gases leaving the turbine or the turbines.

FIG. 1 shows a partial schematic of a fan 1 of an aircraft turbomachine.

The fan 1 comprises a wheel 2 with vanes which is surrounded by a fan housing 3, also referred to as a retention housing due to its retention function in the event of debris ingestion into the fan or vane loss.

The fan housing 3 typically comprises an annular casing 9 of axis of revolution A which extends around the fan vanes 2 of the turbomachine. This casing comprises an annular attachment flange 3′, 3″ at each of its axial ends. These flanges 3′, 3″ are used to attach the housing 3 to annular walls of the nacelle of the turbomachine.

The fan housing 3 is connected upstream to an air inlet sleeve, not shown, and downstream to an intermediate housing shroud 6.

The housing also comprises an upstream acoustic shroud 7 and a downstream acoustic panel 8. The fan housing 3 further comprises an annular layer 4, referred to as abradable support cartridge, arranged on an internal annular surface 9′ of the casing 9, between the upstream shroud 7 and the downstream panel 8. The abradable support cartridge 4 carries an annular layer 4′ of abradable material, the latter forming, together with the shroud 7 and the downstream panel 8, the profile of the aerodynamic duct 1a of the turbomachine 1.

The main function of the abradable support cartridge 4 is to support the layer of abradable material 4′ and to fill the clearance J (FIG. 1) provided between the body 9b of the casing 9 and the vanes 2 to avoid their direct contact in case of an event beyond normal operation, such a contact could lead to a catastrophic resonance phenomenon.

The functions of the abradable support cartridge 4 are of two types:
mechanical, on the one hand:
   support the layer of abradable material 4′,
   fill the above-mentioned clearance J,
   withstand the pressure field that can be exerted in the duct of the turbomachine 1 during its operation,
   resist the ingestion of ice,
   allow the evacuation of the smokes in the event of a fire in the compartment of the nacelle;
   aerodynamics, on the other hand, in order to guarantee the profile of the duct.

FIG. 2 shows an abradable support cartridge 4. This abradable support cartridge 4 comprises a core of NIDA 15 (i.e., honeycomb material), a carbon fibre coating 14 and layers of intumescent material 20, or densification layers. The densification layers 20 are arranged at the upstream and downstream ends of the NIDA core 15. The carbon fibre coating 14 is structured so as to casing the densification layers 20 and the NIDA core 15 on three sides 13a, 13b and 13c. A fourth side 13d, namely the radial outer surface of the core 15, is intended to be glued to the internal surface 9′ of the casing 9 and is free of the carbon fibre coating 14.

In detail, the carbon fibre coating 14 here comprises four thicknesses of carbon fibre plies 16, 17, 18 and 19. The first thickness of plies 16 is the one that envelops the densification layers 20 and the NIDA core 15 on three sides 13a, 13b and 13c, strictly speaking. These plies 16 thus form on the one hand the outer surface of the duct 1a on the inner side 13b of the abradable support cartridge 4, and on the other hand the coating on the upstream 13a and downstream 13c sides of the cartridge 4. The plies 17 of the second thickness, which are shorter than the plies 16 of the first thickness, extend exclusively longitudinally, inside the core 15 and the layers 20. The third and fourth thicknesses of plies 18 and 19 are interposed between the plies 17 on the one hand, and the core 15 and the downstream layer 20 on the other. The plies 18 and 19 form a reinforcement area 4b in the downstream portion 4a, thus increasing the local thickness of the abradable support cartridge 4, and thus the mechanical inertia, i.e. the square moment, and the stiffness of the cartridge 4. In detail, the plies 19 are of shorter axial length than the plies 18, and each form a local allowance 4b″ and 4b′ respectively (FIG. 2). Note that the downstream portion 4a corresponds to a narrowing of the internal diameter of the cartridge 4.

FIG. 3 also shows partially a cross-section of a fan of an aircraft turbomachine 1 according to the prior art, showing the path that a block of ice B can follow between a forward cone 10, at the centre of the turbomachine 1 and aligned with the longitudinal axis A, and a downstream portion 4a of the abradable support cartridge 4. The generation of such a block of ice B of ice can be carried out under icing conditions in the laboratory to reproduce the conditions of ice formation at the cruising altitude of the aircraft: the turbomachine 1 is driven to rotate at maximum speed in a low temperature, high humidity cloud. Ice forms on the cone 10 by accretion. At a critical ice thickness, a significant piece, such as the ice block B, breaks off and is expelled at high speed into the duct 1a. The ice block B then passes the vanes 2 of the rotor and strikes the downstream portion 4a of the abradable support cartridge 4, for example at a point I (FIG. 3). This results in a sometimes complete loss of the abradable material layer 4′ and a damage to the carbon fibre fabrics of the abradable support cartridge 4. FIG. 4 shows the downstream portion 4a of the abradable support cartridge 4 after such a test to reproduce icing conditions. This results in the appearance of craters 40 in the carbon fibre structure.

At present, it is not possible to replace an abradable support cartridge 4 with such damage on the engines already in service, i.e., mounted on an aircraft. If the abradable support cartridge 4 should undergo damages during manufacture, it could be replaced, but this would be difficult and costly as it is glued to the casing 9. It would therefore be necessary to peel it off, taking care not to damage the casing 3. A new abradable support cartridge 4 could then be fitted, which would require an autoclave cure cycle. Such a replacement is therefore costly, delicate and time-consuming, and is therefore undesirable.

The invention therefore aims to propose an aircraft turbomachine housing with an abradable support cartridge that has an improved service life, in particular in the event of ice impact.

### SUMMARY OF THE INVENTION

The invention thus relates to an aircraft turbomachine housing, comprising an annular casing extending around a longitudinal axis and having an internal annular surface, the housing also comprising an annular abradable support cartridge which is attached against said internal annular surface, the abradable support cartridge has a reinforced coating comprising a fibrous texture reinforcement embedded in a resin matrix, the fibrous texture reinforcement comprising a fibrous texture ply stack, wherein the ply stack comprises at least one ply made of Kevlar® or of glass fibre.

Thus, according to the invention, the mechanical strength of the abradable support cartridge to the impact is improved, in particular in the event of ice and rotor vane impact. By providing impact-resistant fabrics, the damage from such impacts is also limited or eliminated.

The housing according to the invention may comprise one or more of the following characteristics, considered independently or in combination with each other:
plies of said stack of fibrous texture plies form a reinforcement area at a downstream portion of the abradable support cartridge;
said plies of the reinforcement area form a local allowance, in particular in radial direction;
the at least one Kevlar® or glass fibre ply extends at least partially into said downstream portion of the abradable support cartridge;
the at least one Kevlar® or glass fibre ply extends over more than half the axial length of the abradable support cartridge;
the at least one Kevlar® or glass fibre ply forms a radially inner coating of the abradable support cartridge and/or is configured to form an outer wall of a duct of the turbomachine;
the at least one Kevlar® or glass fibre ply also forms a peripheral layer on the upstream side and the downstream side of the abradable support cartridge;
the at least one ply of Kevlar® or glass fibre is a woven Kevlar® fabric;
said woven Kevlar® fabric is pre-impregnated with resin;
a thickness of mixed Kevlar® and carbon fibre woven fabric is stacked
radially outwardly on said Kevlar® woven fabric;
said Kevlar®-carbon fibre mixed woven fabric has a ratio of Kevlar® fibres to carbon fibres of between 40/60 and 60/40;
said ratio is between 45/55 and 55/45;
said ratio is 50/50;
the at least one Kevlar® or glass fibre ply is made of glass fibre, and a thickness of carbon fibre plies is stacked radially outwardly on said glass fibre ply;
the at least one ply of Kevlar® or glass fibre is sandwiched between two thicknesses of carbon fibre plies;
the abradable support cartridge comprises a honeycomb core;
a face of said core is free of the at least one Kevlar® or glass fibre ply;
the honeycomb core is impregnated with epoxy resin; and
the fibrous texture reinforcement is embedded in an epoxy resin matrix.

The invention also relates to an aircraft turbomachine comprising a housing according to one or more of the above characteristics.

### BRIEF DESCRIPTION OF THE FIGURES

Further characteristics and advantages of the invention will become apparent from the following detailed description, for the understanding of which reference is made to the attached drawings in which:

FIG. 1 already discussed shows a partial cross-sectional view of a fan of an aircraft turbomachine according to the prior art;

FIG. 2 shows an abradable support cartridge;

FIG. 3 also shows partially a cross-section of a fan of an aircraft turbomachine according to the prior art, showing the path that a block of ice can follow between a forward cone at the centre of the turbomachine and a downstream portion of an abradable support cartridge;

FIG. 4 shows very schematically a downstream portion of an abradable support cartridge of FIG. 3 tested under icing conditions;

FIG. 5 illustrates a first embodiment of an abradable support cartridge according to the invention;

FIG. 6 illustrates a second embodiment of an abradable support cartridge according to the invention;

FIG. 7 illustrates a third embodiment of an abradable support cartridge according to the invention;

FIG. 8 illustrates a fourth embodiment of an abradable support cartridge according to the invention.

### DETAILED DESCRIPTION OF THE INVENTION

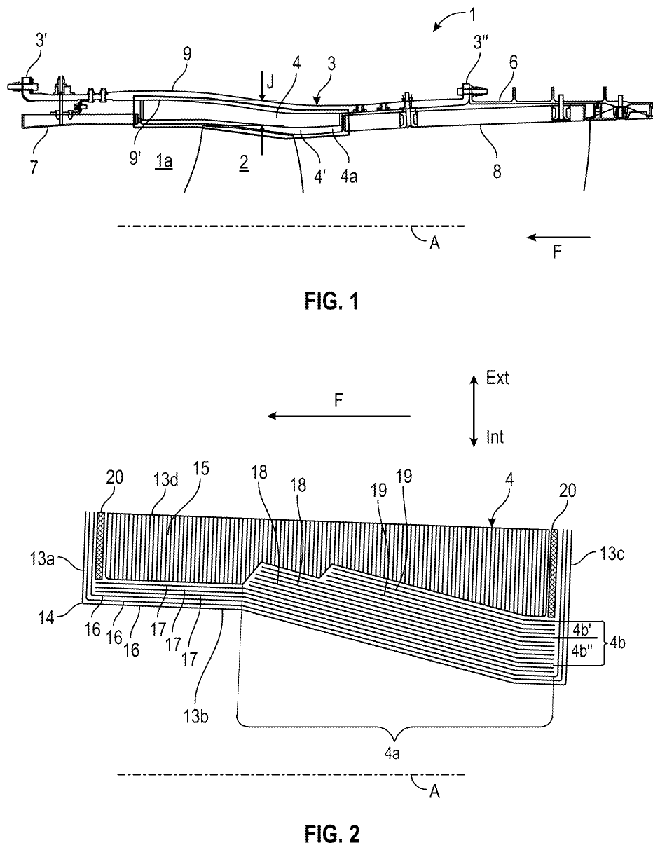

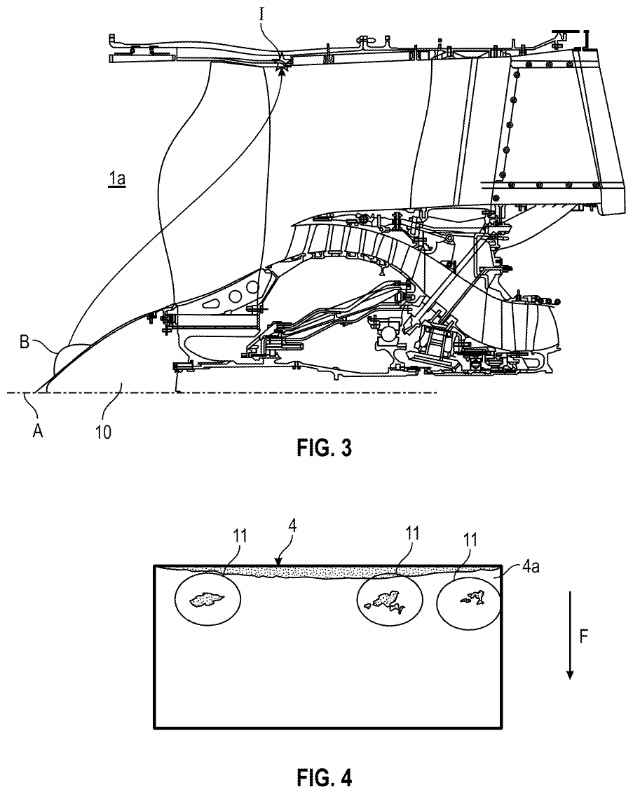

In the following description, the invention is applied to a fan housing such as the housing 3 partially illustrated in FIG. 1. However, the invention is not limited to this type of housing and can be applied to a housing of any other type of turbomachine.

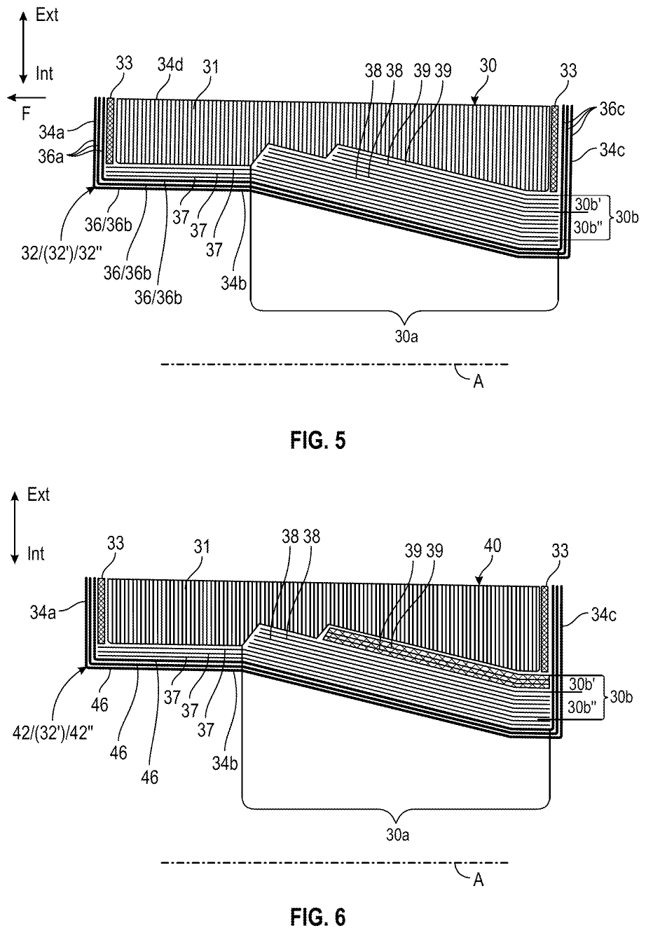

The housing 3 to which the invention applies has a generally annular shape around the longitudinal axis A. An arrow F denotes a forward orientation of the elements shown in relation to their orientation once installed in the turbomachine. A double arrow Ext-Int in FIGS. 5 to 8 shows a radial direction and the inward and outward orientations of the turbomachine 1 when the abradable support cartridges 30, 40, 50 and 60 described below are oriented according to their arrangement on a housing 3 of a turbomachine 1 in use on an aircraft.

The housing 3 comprises an annular casing 9 which itself extends around the axis A (FIG. 1).

An annular or annulus-sector abradable support cartridge, such as the abradable support cartridges 30, 40, 50 or 60 described below, is arranged on an internal surface 9′ of the annular casing 9.

A first embodiment of an abradable support cartridge 30 is illustrated in FIG. 5. Second, third and fourth embodiments of abradable support cartridges 40, 50 and 60 respectively are illustrated in FIGS. 6, 7 and 8 and will be described later.

In the embodiment shown in FIG. 5, the abradable support cartridge 30 comprises a NIDA core 31 (i.e., honeycomb material), a reinforced coating 32, made of composite material, and densification layers 33. The densification layers 33 are arranged at the upstream and downstream ends of the NIDA core 31, radially. The reinforced coating 32 is structured so as to casing the NIDA core 31 and the densification layers 33 on three sides 34a, 34b and 34c. A fourth side 34d, namely the radial outer surface of the core 31, is intended to be glued to the internal surface 9′ of the casing 9 and is free of the coating 32.

In detail, the coating 32 comprises a fibrous texture reinforcement 32″, comprising a stack of fibrous texture plies, embedded in a resin matrix 32′. In the illustrated embodiment, the reinforcement 32″ comprises four thicknesses of fibrous texture plies 36, 37, 38 and 39. The resin 32′ is preferably, but not restrictively, an epoxy resin. An epoxy resin should preferably also be impregnated into the NIDA core to ensure the best possible chemical compatibility. The first thickness of plies 36 is that which envelops the NIDA core 31 and the densification layers 33 on three sides 34a, 34b and 34c, strictly speaking. These plies 36 thus form, with their longitudinally extending middle portion 36b, the radially inner layer of the abradable support cartridge 30 on the radially inner side 34b thereof, i.e., the outer wall of the duct 1a of the turbomachine 1. The plies 36 furthermore form, by their radially and outwardly oriented folds 36a and 36c, the peripheral layer of the cartridge 30 on the upstream 34a and downstream 34c sides, i.e. form the upstream face and downstream face of the cartridge 30. The plies 37, 38 and 39 are sandwiched radially between the plies 36 and the NIDA core 31. Radially and from the inside towards the outside of the cartridge 30, the plies 36 to 39 and the core 31 are stacked as follows: the middle portions 36b of the plies 36 made of Kevlar®, the plies 37, 38 and 39 made of carbon fibres, and the core made of NIDA 31. The plies 37 of the second thickness, which are shorter than the plies 36 of the first thickness, extend here exclusively longitudinally, radially inwards from the NIDA core 31 and the densification layers 33. The third and fourth thicknesses of plies 38 and 39, shorter than the plies 37 and extending along the NIDA core 31 for a length less than the axial length of the core 31, are interposed between the plies 37 on the one hand, and the core 31 and the downstream densification layer 33 on the other. The plies 38 and 39 form a reinforcement area 30b in the downstream portion 30a. Finally, the plies 39 are here of shorter axial length than the plies 38, and each form a local allowance 30b″ and 30b′ respectively (FIG. 5).

In the embodiment shown in FIG. 5, the plies 36 are made of Kevlar® fabric. The plies 36 are here three in number but one, two, four, five or more plies may be provided. Kevlar® has the advantage of improved impact resistance compared to carbon fibres. The carbon fibre fabrics 37-39 arranged internally (i.e., within the abradable support cartridge 30) are thus protected from impact, thereby limiting or eliminating the risk of damage requiring replacement of the abradable support cartridge 30 during the service life of the turbomachine 1. In addition, Kevlar® is a less dense material than carbon fibre. With the same number of plies, replacing carbon fibre plies with Kevlar® plies thus allows to lighten the abradable support cartridge 30 compared to the prior art.

The plies 37 to 39 are made of carbon fibre. A certain number of these should be retained in order to ensure the modal strength of the housing 3 (its resistance to vibratory stresses). Preferably, there are three to five plies 37. Preferably, the number of plies 38 is between three and six (six in the embodiment shown in FIG. 5, for example). Preferably, there are three to five plies 39.

Second, third and fourth alternative embodiments to the first embodiment are described below, with reference to FIGS. 6, 7 and 8 respectively, without however being limiting of the invention. In these, the identical elements have the same references and are not repeated in the following description.

Compared to the first embodiment, in a second embodiment of the abradable support cartridge 40 shown in FIG. 6, a reinforced coating 42 comprising a fibrous texture reinforcement 42″ which comprises glass fibre plies 46 is provided. The plies 46 replace the Kevlar® plies 36 of the coating 32. The reinforced coating 42 also comprises plies 37, 38 and 39, here identical in composition and arrangement to those of the coating 32.

The plies 46 are here three in number but one, two, four, five or more plies may be provided. The glass fibres have the advantage of improved impact resistance compared to carbon fibres. The carbon fibre fabrics 37, 38 and 39 arranged internally (i.e., within the abradable support cartridge 40) are thus protected from impact, thereby limiting or eliminating the risk of damage requiring a replacement of the abradable support cartridge 40.

The plies 38 and 39 form a reinforcement area 30b in the downstream portion 30a. Finally, the plies 39 are here of shorter axial length than the plies 38, and each form a local allowance 30b″ and 30b′ respectively.

As can be seen in FIG. 6 by way of example, the improved impact resistance of the abradable support layer 40 allows carbon fibre plies, such as the plies 39, to be eliminated where appropriate. In such a case, the NIDA 31 core can be thickened to replace the removed carbon fibre plies 39.

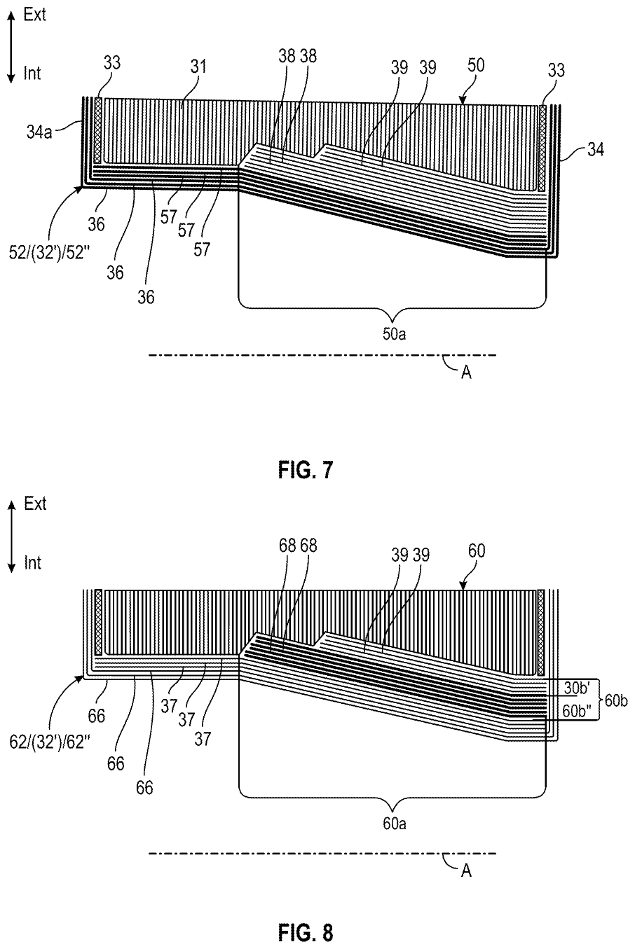

Compared to the first embodiment, in a third embodiment of the abradable support cartridge 50 shown in FIG. 7, a reinforced coating 52 comprising a fibrous texture reinforcement 52″ which comprises plies 57 of Kevlar®-carbon hybrid fabric is provided. The plies 57 replace the carbon fibre plies 37 of the coating 32. The reinforced coating 52 also comprises plies 36, 38 and 39, here identical in composition and arrangement to those of the coating 32.

Preferably, but not restrictively, the proportion of Kevlar®-carbon in the plies 57 is chosen to be balanced. A suitable ratio can then be chosen from a volume ratio, a mass ratio, or a fibre number ratio. For example, the plies 57 have a ratio of the number of Kevlar® fibres to the number of carbon fibres of between 40/60 and 60/40 (i.e., the proportion of the Kevlar® fibres to the total number of fibres is between 40 and 60% and the proportion of carbon fibres is 60 to 40% respectively). Even more preferably, this ratio is between 45/55 and 55/45. In a very preferable way, this ratio is 50/50. By analogy, the ratio chosen can be the volume relationship between Kevlar® and carbon, or the mass relationship between Kevlar® and carbon, based on the same numerical ratios.

This hybrid ply embodiment 57 allows a smoother, i.e., more gradual, transition between the properties of the Kevlar® plies 36 and the carbon fibre plies 38 and 39. This embodiment also provides a reinforced downstream portion 50a (FIG. 7). An excellent mechanical and chemical consistency is thus achieved. In an advantageous example of plies 57, which is non-limiting and not illustrated in detail, the warp threads are made of carbon while the weft threads are made of Kevlar®. Such an example of a configuration of the plies 57 allows for simple weaving while allowing for a gradual transition between the plies 36 and 38, i.e., limiting the mechanical problems at the interfaces between the successive plies of different types.

The Kevlar® plies 36 are three in number here, but one, two, four, five or more plies can be provided. There are three plies 57 of Kevlar®-carbon hybrid fabric, but one, two, four, five or more plies can be provided.

Compared to the first embodiment, in a fourth embodiment of the abradable support cartridge 60 shown in FIG. 8, a reinforced coating 62 comprising a fibrous texture reinforcement 62″ which comprises on the one hand a thickness of plies 68 made of glass fibres or Kevlar® and on the other hand plies made of carbon fibres 66 is provided. The plies 68 replace the carbon fibre plies 38 of the coating 32. The plies 66 replaces the Kevlar® 36 plies. The ply thickness 68 made of glass fibre or Kevlar® is thus sandwiched between two ply thicknesses 37 and 39 made of carbon fibre. Radially and from the inside to the outside of the cartridge 60, the plies 36 to 39 and the core 31 are stacked as follows, at the downstream portion 60a of the cartridge 60: the middle portions 36b of the plies 36 and 37 made of carbon fibres, the plies 68 made of glass fibres or Kevlar®, the plies 39 made of carbon fibres, and the core 31 made of NIDA.

There are six glass fibre or Kevlar® plies 68, but one, two, three, four, five or more than six plies can be provided.

This alternative also allows to improve the impact strength of the abradable support cartridge 60, in particular in a reinforcement area 60b in the downstream portion 60a of the abradable support cartridge 60, compared to the prior art. The reinforcement area then comprises an allowance 30b′ (as mentioned above) and an allowance 60b″ formed by plies 68

In the first to third embodiments, the reinforced coatings are arranged on the surface, thus optimally protecting the carbon fibre plies 38, 39 and, if applicable, the plies 37.

The invention brings advantages on several levels. From a technical point of view:
Kevlar® used as a reinforcement has an improved impact strength (ice and/or rotor vane impacts) and allows for weight savings due to a lower density than the carbon fibres;
the glass fibres used as reinforcement have an improved impact strength (ice and/or rotor vane impacts).

From an industrial point of view:
Due to the higher impact strength, the abradable support cartridges according to the invention can enjoy an extended service life. This eliminates the need to replace the abradable support cartridge in a turbomachine housing, such as a fan housing, in the event of ice impact;
the improved impact strength allows for the removal of carbon fibre plies where appropriate (e.g., by thickening the material to NIDA to replace the removed carbon fibre plies). In such a case, the invention allows to save on material costs and shortens the cycle time during the manufacture.

The invention therefore brings significant technical and industrial gains.

1. An aircraft turbomachine housing, comprising an annular casing extending about an axis A and having an internal annular surface, the housing also comprising an annular abradable support cartridge which is attached against said internal annular surface, the abradable support cartridge has a reinforced coating comprising a fibrous texture reinforcement embedded in a resin matrix, the fibrous texture reinforcement comprising a stack of fibrous texture plies,
characterised in that the stack of plies comprises at least one ply made of Kevlar® or of glass fibres.

2. The aircraft turbomachine housing according to claim 1, wherein plies of said stack of plies of fibrous texture form a reinforcement area at a downstream portion of the abradable support cartridge.

3. The aircraft turbomachine housing according to the claim 2, wherein said plies of the reinforcement area form a local allowance.

4. The aircraft turbomachine housing according to claim 1, wherein the at least one Kevlar® or glass fibre ply extends over more than half the axial length of the abradable support cartridge.

5. The aircraft turbomachine housing according to claim 1, wherein the at least one Kevlar® or glass fibre ply forms a radially inner coating of the abradable support cartridge.

6. The aircraft turbomachine housing according to claim 1, wherein the at least one Kevlar® or glass fibre ply is configured to form an outer wall of a duct of the turbomachine.

7. The aircraft turbomachine housing according to claim 1, wherein the at least one Kevlar® or glass fibre ply also forms a peripheral layer on the upstream side and/or the downstream side of the abradable support cartridge.

8. The aircraft turbomachine housing according to claim 1, wherein the at least one Kevlar® or glass fibre ply is a woven Kevlar® fabric.

9. The aircraft turbomachine housing according to the preceding claim 1, wherein said woven Kevlar® fabric is pre-impregnated with resin.

10. The aircraft turbomachine housing according to claims 8 and 9, wherein a thickness of mixed Kevlar®-carbon fibre woven fabric is stacked radially outwardly on said Kevlar® fabric.

11. The aircraft turbomachine housing according to any of claims 1 to 7, wherein the at least one Kevlar® or glass fibre ply is made of glass fibre, and wherein a thickness of carbon fibre plies is stacked radially outwardly on said glass fibre ply.

12. The aircraft turbomachine housing according to any one of the preceding claims, the at least one Kevlar® or glass fibre ply is sandwiched between two thicknesses of carbon fibre plies.

13. The aircraft turbomachine housing according to claim 1, wherein the abradable support cartridge comprises a honeycomb core.

14. The aircraft turbomachine housing according to claim 13, a face of the core is free of the at least one Kevlar® or glass fibre ply.

15. An aircraft turbomachine comprising a housing according to claim 1.
